(19) United States
(12) Patent Application Publication
(10) Pub. No.: US 2015/0327550 A1
(43) Pub. Date: Nov. 19, 2015

(54) ENVIRONMENT-FRIENDLY, BIODEGRADABLE, VOC-FREE, NON-CORROSIVE AQUEOUS SOLUTION OF 1, 2-BENZISOTHIAZOLIN-3-ONE (BIT) AND PROCESS FOR PREPARING THE SAME

(71) Applicant: ISP INVESTMENTS INC., Wilmington, DE (US)

(72) Inventors: Raman Premachandran, Saddle Brook, NJ (US); Karen Winkowski, Springfield, NJ (US); Najeeb H. Hakimi, Edison, NJ (US); Mariana Milan, Hackettstown, NJ (US)

(73) Assignee: ISP INVESTMENTS INC., Wilmington, DE (US)

(21) Appl. No.: 14/650,336

(22) PCT Filed: Nov. 20, 2013
(86) PCT No.: PCT/US13/70936

§ 371 Date: Jun. 8, 2015

Related U.S. Application Data
(60) Provisional application No. 61/734,440, filed on Dec. 7, 2012.

(51) Int. Cl. A01N 43/80

(52) U.S. Cl. CPC A01N 43/80

(57) ABSTRACT

What is described herein is an environment-friendly, biodegradable, non-corrosive aqueous solution of isothiazolin-3-one comprising: (i) at least about 5 wt. % to about 50 wt. % of 1,2-benzisothiazolin-3-one (BIT); (ii) about 5 wt. % to 15 wt. % of neutralizing agent; (iii) about 0.01 wt. % to about 20 wt. % of at least one biodegradable chelating agent; (iv) about 0.01 wt. % to about 20 wt. % of at least one alkyl polyglucoside, a solubilizer; (v) about 0.1 wt. % to about 2.0 wt. % of polyvinyl alcohol (PVA), a crystal modifier; and (vi) about 50% to about 85% by wt. of water; and wherein said aqueous solution is free from volatile organic compounds (VOC's), glycerols, polyglycerols, derivatives of glycerols, glycols, polyglycols and/or derivatives of glycols, and wherein, the frozen aqueous solution of isothiazolin-3-one is capable of completely thawing within two hours at room temperature or at about 25° C. to about 30° C.

### FIELD OF THE INVENTION

The present application relates to an aqueous solution of biocidal compositions, and more particularly, to an aqueous clear solution of 1,2-benzisothiazolin-3-one (BIT) which is free from volatile organic compounds (VOC), glycerols, derivatives of glycerols, glycols and/or derivatives of glycols.

### BACKGROUND OF THE INVENTION

1,2-benzisothiazolin-3-one (referred to hereinafter as “BIT”) is a well-known industrial biocide which is efficient in protecting aqueous media against microbial attack. It is effective as a bactericide and suited to various industrial applications such as metal working fluids, cooling tower water, emulsions, plastic film, paint, building materials, stucco, concrete, caulks, sealants, joints, adhesives, leather, wood, inks, pigment dispersions, drilling mud, clay slurries, agricultural applications, seed coatings, pesticide compositions, toiletry, household, cleaning, disinfecting, enzyme formulations, laundry products, and the like.

It is advantageous to provide BIT as a highly aqueous solution for its intended use in the various above specified fields. It has been observed in the recent past many of the liquid based BIT formulations explored are with glycol based solvents such as propylene glycols, polyethylene glycols, polyglycols, glycerols and etc. Unfortunately, the continuous oscillation in market price of glycols is a great concern for the manufacturers. As a result, formulations arising out of such glycol based solvents are not cost-effective and are not eco-friendly and/or non-biodegradable. Hence, it is advantageous to have highly aqueous solutions of BIT free from glycol based solvents.

U.S. Pat. No. 7,939,486 assigned to Clorox discloses a natural cleaning composition consisting essentially of: (a) an anionic surfactant selected from the group consisting of sodium lauryl sulfate, sodium alkylalpha-sulfomethyl ester, and combinations thereof; (b) a hydrophilic syndetic selected from the group consisting of C₆ alkyl polyglucoside, C₆ to C₈ alkyl polyglucoside, C₈ alkyl polyglucoside, a C₄ to C₈ alkyl polypentoside and combinations thereof; (c) a hydrophobic syndetic selected from the group consisting of an amine oxide, a fatty acid, a fatty alcohol, a sterol, a sorbitan fatty acid ester, a glycerol fatty acid ester, a polyglycerol fatty acid ester, a C₁₄ to C₂₂ alkyl polypentoside, and combinations thereof; (d) a first organic chelating agent from the group consisting of 2-hydroxyacids, 2-hydroxyacid derivatives, glutamic acid, glutamic acid derivatives, gluconate, and mixtures thereof; (e) a second organic chelating agent selected from the group consisting of DTPA, GLDA, EDDS, TMG, Tiron and combinations; (f) optionally a solvent selected from the group consisting of propylene glycol, 1,3-propanediol, ethanol, sorbitol, glycerol and combinations thereof; (g) optionally a nonionic surfactant selected from the group consisting of alkyl polyglucosides having chain lengths greater than C₈, and combinations thereof; and (h) optional ingredients selected from pH adjusting agents, builders, calcium salts, boric acid or borate, enzymes, dyes, colorants, fragrances, preservatives, fluorescent whitening agents, bluing agents, defoamers, bleaches, thickeners, anti-redeposition polymers, and combinations thereof.

PCT Publication No. WO2012158425A1 by ISP Investments Inc. discloses an environment-friendly highly aqueous clear solution of 1,2-benzisothiazolin-3-one (BIT) comprising: (i) about 0.1 to about 30% by wt. of 1,2-benzisothiazolin-3-one; (ii) about 5 to 15% by wt. of alkali metal salt; (iii) about 50% to about 85% by wt. of water; and (iv) about 0.1% to about 5% by wt. of chelating agent; and wherein said aqueous solution is free from volatile organic compounds (VOC), glycerols, derivatives of glycerols, glycols and/or derivatives of glycols, and wherein said chelating agent is glutamic acid-N,N-diacetic acid tetrasodium salt.

PCT Publication No. WO2003007716A1 by MAKHTESHIM CHEM WOKS LTD. discloses a liquid pesticidal composition comprising one or more azole fungicide and polyvinyl alcohol (PVA) as a crystal growth inhibitor.

U.S. Pat. No. 7,666,887 and U.S. Pat. No. 7,105,555 disclose a neutral pH, VOC-free biocidal composition consisting essentially of by weight, about 0.1-30%, 1,2-benzisothiazolin-3-one (BIT), about 20-90% polyethylene glycol (PEG) of molecular weight 400 or more, about 0-3%, preferably 1.5-2.5% sodium hydroxide (NaOH), KOH or LiOH and about 0-15%, preferably 5-10% water. These compositions are stable at temperatures as low as −20° C. for an extended period of time. A preferred composition consists essentially of 20% BIT, 70% PEG-400, 2.1% NaOH and 7.9% water.

U.S. Pat. No. 5,684,025 and U.S. Pat. No. 5,585,033 disclose liquid formulations of 1,2-benzisothiazolin-3-one, and methods for making such formulations. Formulations according to this invention contain about 1 to 25 percent by weight 1,2-benzisothiazolin-3-one, about 3 to 7 percent by weight of sodium hydroxide, about 3 to 63 percent by weight of water and about 20 to 65 percent by weight of one or more polyglycol triols.

In view of the foregoing, there remains a need for an environment-friendly, non-corrosive aqueous solution of BIT composition made up of only biodegradable ingredients, which is neutral in pH, VOC-free, stable, glycerol-free, glycol-free and capable of exhibiting biocidal activity against gram (−) negative and gram (+) bacterial strains.

Accordingly, it is an object of this application to provide a new and improved aqueous solution of BIT composition which is stable, has a neutral pH, and is free from VOC's, organic co-solvents, glycerols, polyglycerols, derivatives of glycerols, glycols, polyglycols and/or derivatives of glycols.

Additionally, there is a necessity for an aqueous solution of BIT which is capable of completely thawing or melting the frozen aqueous solution of BIT within a few hours of room temperature or at about 25° C. to about 30° C., and wherein the frozen form of aqueous solution of BIT is prepared to store, transit or for any other purposes required thereof.

### SUMMARY OF THE INVENTION

What is described herein is an environment-friendly, biodegradable, non-corrosive aqueous biocidal solution comprising: (i) at least about 5 wt. % to about 50 wt. % of 1,2-benzisothiazolin-3-one (BIT); (ii) about 5 wt. % to 15 wt. % of neutralizing agent; (iii) about 0.01 wt. % to about 20 wt. % of at least one biodegradable chelating agent; (iv) about 0.01 wt. % to about 20 wt. % of at least one alkyl polyglucoside, a solubilizer; (v) about 0.1 wt. % to about 2.0 wt. % of polyvinyl alcohol (PVA), a crystal modifier; and (vi) about 50% to about 85% by wt. of water; and wherein said aqueous solution of BIT is free from volatile organic compounds (VOC's), glycerols, polyglycerols, derivatives of glycerols, glycols, polyglycols and/or derivatives of glycols, and wherein, the frozen aqueous solution of isothiazolin-3-one (BIT) is capable of completely thawing or melting within two hours at room temperature or at about 25° C. to about 30° C.

One important aspect of the present application is to provide an aqueous solution of BIT which is environment-friendly, biodegradable, non-corrosive, neutral to slightly alkaline pH, i.e. 7.5 to 8.5, and free from volatile organic compounds (VOC's), glycerols, polyglycerols, derivatives of glycerols, glycols, polyglycols and/or derivatives of glycols.

According to another important aspect of the present application, the frozen aqueous solution of BIT is capable of completely thawing or melting within two hours at room temperature or at about 25° C. to about 30° C.

Yet another aspect of the present application is to provide an aqueous composition of BIT which is storage-stable, transit-stable, easily-flowable, non-drying, non-crystallizable, dilution-stable and easily incorporable in numerous aqueous based industrial applications.

According to another aspect of the present application, the aqueous solution of BIT composition is capable of inhibiting or killing gram (+) bacterial strains, gram (−) bacterial strains, fungi, yeasts and/or mold spores.

In accordance with another aspect of the present application, a process for preparing an environment-friendly, biodegradable, non-corrosive aqueous BIT solution comprises: preparing a homogenous mixture of (a) at least about 5 wt. % to about 50 wt. % of 1,2-benzisothiazolin-3-one (BIT) which is pre-neutralized with a neutralizing agent; (b) about 0.01 wt. % to about 20 wt. % of at least one biodegradable chelating agent; (c) about 0.01 wt. % to about 20 wt. % of at least one alkyl polyglucoside, a solubilizer; (d) about 0.1 wt. % to about 2.0 wt. % of polyvinyl alcohol (PVA), a crystal modifier; and (e) about 50 wt. % to about 85 wt. % of water by high shear mixing in a reactor for 30 minutes.

In accordance with a further objective of the present application, the aqueous solution of BIT prepared according to the above process is employed in the field of paint, latex, coatings, building materials, stucco, concrete, caulks, sealants, joints, adhesives, leather, wood, inks, pigment dispersions, metal working fluids, drilling mud, clay slurries, agricultural applications, seed coatings, pesticide compositions, toiletry, household, cleaning, disinfecting, enzyme formulations, in-can preservation, laundry amongst other.

### DETAILED DESCRIPTION OF THE INVENTION

While this specification concludes with claims particularly pointing out and distinctly claiming that, which is regarded as the invention it is anticipated that the invention can be more readily understood through reading the following detailed description of the invention and study of the included examples.

By the term “comprising” herein is meant that various optional, compatible components can be used in the compositions herein, provided that the important ingredients are present in the suitable form and concentrations. The term “comprising” thus encompasses and includes the more restrictive terms “consisting of” and “consisting essentially of” which can be used to characterize the essential ingredients such as water, BIT, chelating agent, solubilizer and neutralizing agent of the present aqueous BIT compositions.

All percentages, parts, proportions and ratios as used herein, are by weight of the total composition, unless otherwise specified. All such weights as they pertain to listed ingredients are based on the active level and, therefore; do not include solvents or by-products that may be included in commercially available materials, unless otherwise specified.

All references to singular characteristics or limitations of the present invention shall include the corresponding plural characteristic or limitation, and vice-versa, unless otherwise specified or dearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

The term “about” can indicate a variation of 10 percent of the value specified; for example about 50 percent carries a variation from 45 to 55 percent. For integer ranges, the term about can include one or two integers greater than and less than a recited integer.

As used herein, the words “preferred,” “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

References herein to “one embodiment,” “one aspect” or “one version” or “one objective” of the invention include one or more such embodiment, aspect, version or objective, unless the context clearly dictates otherwise.

All publications, articles, papers, patents, patent publications, and other references cited herein are hereby incorporated herein in their entireties for all purposes to the extent consistent with the disclosure herein.

The term “biocide” or “antimicrobial” as used herein is to be understood to refer to agents such as germicides, bactericides, fungicides, algicides, aquaticides, herbicide, insecticide, larvicide, pesticide, rodenticide, taeniacide, plant growth regulators and the like, which are used for their ability to inhibit growth of and/or destroy biological and/or microbiological species such as bacteria, fungi, algae, caterpillar, insects, larvae, mildew, rodents, spider, worm and the like.

Herein, “stable” and “stability” mean a composition which is significantly unaffected in chemical nature, physical homogeneity and/or color upon exposure to conditions reasonably expected to be incurred in transport, storage and use. Stability may be determined either by empirical observation or by suitable methods of chemical and/or physical examination that would be known to one of skill in the art.

The term “environmentally friendly” means, without limitation, no adverse affect on the environment. More particularly, environmentally friendly (also eco-friendly, nature friendly, and green) are synonyms used to refer to goods and services, laws, guidelines and policies considered to inflict minimal or no harm on the environment or may rebuild or renew resources through their use.

The term “biodegradable” means that the composition can be degraded by an appropriate natural means such as bacteria, fungi, algae, and enzymes alone or in combination with natural environmental factors such as hydrolysis, trans-esterfication, UV degradability. The biodegradability nature of such composition is capable of reducing environmental pollution/hazards.

The term “sequestering agent” and “chelating agent” is used synonymously in the entire application. Further, the “sequestering agent” or “chelating agent” as used in this specification and claims relates to a compound which is capable of bonding or complexing a metal ion between two or more atoms of the compound, thereby neutralizing or controlling harmful effects of such metal ions, wherein the holding or bonding of a metal ion is through a combination of one or more different types of bonds including coordination and/or ionic bonds.

The term “Volatile Organic Compounds (VOC)-free” as used herein referring to a composition of the present application means that no external solvent constituent has been added in the present aqueous composition at any point of time and it should be understood by one of ordinary skill in the art that residual solvents may be present inherently in commercially available or synthesized products which may or may not be part of the aqueous composition of the present application and wherein the inherent presence of residual solvent is not precluded by use of the term “Volatile Organic Compounds (VOC)-free”.

The present application describes an environment-friendly, biodegradable, non-corrosive aqueous biocidal solution comprising: (i) at least about 5 wt. % to about 50 wt. % of 1,2-benzisothiazolin-3-one (BIT); (ii) about 5 wt. % to about 15 wt. % of neutralizing agent; (iii) about 0.01 wt. % to about 20 wt. % of at least one biodegradable chelating agent; (iv) about 0.01 wt. % to about 20 wt. % of at least one alkyl polyglucoside, a solubilizer; (v) about 0.1 wt. % to about 2.0 wt. % of polyvinyl alcohol (PVA), a crystal modifier; and (vi) about 50% to about 85% by wt. of water; and wherein said aqueous solution is free from volatile organic compounds (VOC's), glycerols, polyglycerols, derivatives of glycerols, glycols, polyglycols and/or derivatives of glycols, and wherein, the frozen aqueous solution of isothiazolin-3-one (BIT) is capable of completely thawing within two hours at room temperature or at about 25° C. to about 30° C.

The preferred ranges of BIT of the present application include but are not limited to about 5 wt. % to about 10 wt. %; about 11 wt. % to about 15 wt. %; about 16 wt. % to about 20 wt. %; about 21 wt. % to about 25 wt. %; about 26 wt. % to about 30 wt. %; about 31 wt. % to about 35 wt. %; about 36 wt. % to about 40 wt. %; about 41 wt. % to about 45 wt. %; about 46 wt. % to about 50 wt. %.

Embodiments of the present application use a neutralizing agent to produce neutralized BIT for preparing the aqueous solution of BIT. The neutralizing agent is selected from the group including, but not limited to, alkali metal salts and alkaline earth metal salts. The “alkali metal salt” or “alkaline earth metal salts” used to neutralize the BIT is not particularly limited as long as it is a salt with an alkali metal. Specific examples of the alkali metal salt include sodium salts, potassium salts, magnesium salts, calcium salts or the like, with sodium/potassium salts or the like being preferable example. Specific examples of the base containing the alkali metal include but are not limited to sodium hydroxide, sodium ethoxide, sodium methoxide, sodium hydride, potassium hydroxide, potassium ethoxide, potassium methoxide, potassium hydride and solutions of the foregoing. The preferred ranges of neutralizing agent required for the present application include but are not limited to about 5 wt. % to about 10 wt. %; about 11 wt. % to about 15 wt. %.

It is contemplated to employ other possible neutralizing agents to produce neutralized BIT for purposes of the present application including, but not limited to, alkanolamines, alkyl amines, mono-alkyl alkanolamines, di-alkyl alkanolamines, tri-alkyl alkanolamines, primary amines, secondary amines, tertiary amines, quaternary amines and/or alkyl tertiary amines, alkoxylated amines, methoxylated alkylamines, ethoxylated alkylamines, alkoxylated alkanolamines, phenol amines, polymeric amines, alone or in combination.

The environment-friendly, biodegradable aqueous solution of BIT comprises at least one biodegradable chelating agent selected from the group consisting of S,S-ethylenediaminedisuccinic acid (EDDS), Ethylene diamine-N,N′-disuccinic acid, or alkali or alkaline earth salts, Trisodium ethylene diamine-N,N-disuccinate (EDDS), (S,S)-Iminodisuccinic acid, (S,R)-Imino-disuccinic acid, hydroxyiminodisuccinic acid (HIDS), Trisodium methylglycine-N,Ndiacetate, Cysteic acid-N,N-diacetic acid, Cysteic acid-N-monoacetic acid, Alanine-N-monoacetic acid, β-Alanine-N,N-diacetic acid, (S)-α-Alanine-N,N-diacetic acid, N-[2-(3-Hydroxysuccinyl)]-L-serine, Methyliminodiacetic acid and their alkali metal salts, (S)-Aspartic acid-monoacetic acid, (S)-Aspartic acid-N,N-diacetic acid, (S)-Aspartic acid-N,N-diacetic acid tetrasodium salt (ASDA), (S)-Aspartic acid-monopropionic acid, N-(3-Hydroxysuccinyl)-aspartic acid, (S)-2-Sulfomethylaspartic acid, (S)-2-Sulfoethylaspartic acid, (S)-Glutamic acid-N,N-diacetic acid, (S)-2-Sulfomethylglutamic acid, (S)-2-Sulfoethylglutamic acid, (S)-Serine-N,N-diacetic acid, (S)-Phenylalanine-N,N-diacetic acid and alkali metal salts, Glutamic acid diacetic acid (GLDA), a GLDA salt, a GLDA derivative, a tetrasodium or ammonium salt of GLDA, Methylglycine diacetic acid (MGDA), Polyamino disuccinic acids, N-bis-[2-(1,2-Dicarboxyethoxy)ethyl]glycine (BCA6), N-bis-[2-(1,2-Dicarboxyethoxy)ethyl]aspartic acid (BCA5), N-bis-[2-(1,2-Dicarboxyethoxy)ethyl]-methylglycine (MCBA5), N-tris-[(1,2-Dicarboxyethoxy)ethyl]amine (TCA6), N-Methyliminodiacetic acid (MIDA), Iminodiacetic acid (IDA), N-(2-Acetamido)iminodiacetic acid (ADA), Hydroxymethyl-iminodiacetic acid, 2-(2-Carboxyethylamino)succinic acid (CEAA), 2-(2-Carboxymethylamino)succinic acid (CMAA), Diethylenetriamine-N,N″-disuccinic acid, Triethylenetetramine-N,N′″-disuccinic acid, 1,6-Hexamethylenediamine-N,N′-disuccinic acid, Tetraethylenepentamine-N,N″″-disuccinic acid, 2-Hydroxypropylene-1,3-diamine-N,N′-disuccinic acid, 1,2-Propylenediamine-N,N′-disuccinic acid, 1,3-Propylenediamine-N,N′-disuccinic acid, cis-Cyclohexanediamine-N,N′-disuccinic acid, trans-Cyclohexanediamine-N,N′-disuccinic acid, Ethylene-bis-(oxyethylenenitrilo)-N,N′-disuccinic acid, Glucoheptanoic acid, or alkali metal salts of any of the above said biodegradable chelating agents, alone or in combination.

The most preferred sequestering agents of the present application are glutamic acid-N,N-diacetic acid tetrasodium salt (GLDA-Na₄), S,S-ethylenediaminedisuccinic acid (EDDS), (S)-Aspartic acid-N,N-diacetic acid tetrasodium salt (ASDA), tetrasodium salt of Hydroxy-imino-di-succinic acid (HIDS), or Tetrasodium Imino-di-succinate.

The preferred usable range of chelating agent is from about 0.01 wt. % to about 20 wt. %. The other possible usable ranges are about 0.01 wt. % to about 5 wt. %; about 5.1 wt. % to about 10 wt. %; about 10.1 wt. % to about 15 wt. %; about 15.1 wt. % to about 20 wt. %. The particularly preferred range is from about 0.5 wt. % to about 4.0 wt. %, based on the total aqueous solution of BIT.

Alkyl glucosides (AGs) and alkyl polyglucosides (APGs) are a relatively new generation of highly effective carbohydrate-derived surfactants or solubilizers that are low in toxicity, eco-friendly, and made from renewable natural resources at very low cost. They are completely biodegradable, both aerobically and anaerobically. The AGs and APGs made of hydrophilic plus hydrophobic parts result in typically complex mixtures of compounds with different sugars comprising the hydrophilic end and alkyl groups of variable length comprising the hydrophobic end. The hydrophilic part of the molecule, derived from glucose or dextrose, maybe obtained from starch, most commonly from corn. The hydrophobic fatty alcohols part is derived from sources such as coconut, palm kernel oils. It is a class of nonionic surfactants widely used in a variety of household and industrial applications such as cosmetics products, agriculture formulations, household and industrial formulations. It is reported to have a good compatibility with the eyes, skin and mucous membranes. Additionally, they exhibit good wetting, dispersing, surface tension reduction, caustic stability, builder compatibility, detergent ability, and/or hydrotrope ability collectively offer greater flexibility for a person skilled in the art.

Suitable alkyl polyglucosides of the present application include C₆-C₁₆ alkyl polyglucoside. The preferred alkyl glucoside of the present application is selected from C₆-C₈ alkyl polyglucoside. The commercially available alkyl polyglucosides include AG6202®, AG6206®, AG6210® from Akzo-Nobel®. The amount of alkyl polyglucosides present can range from about 0.01 wt. % to about 20 wt. %, or about 0.01 wt. % to about 5.0 wt. %, 5.1 wt. % to about 10.0 wt. % 10.1 wt. % to about 15.0 wt. %, 15.1 wt. % to about 20.0 wt. %.

According to one important embodiment of the present application, the eco-friendly, biodegradable polyvinyl alcohol (PVA) is employed as a crystal modifier. Without being bound by the theories, it is contemplated that the PVA is capable of modifying the crystal structure of BIT in aqueous solution. As a result, it is capable of reducing the time required for thawing or melting of a frozen aqueous solution of BIT composition of the present application, and wherein the time required for thawing or melting is within two hours at room temperature or at about 25° C. to about 30° C.

In accordance with another aspect of the present application, the aqueous solution of BIT composition is capable of inhibiting or killing microorganisms including gram (+) bacterial strains, gram (−) bacterial strains, yeasts, fungi, molds and/or spores.

The gram (+) and gram (−) bacterial strains include, but are not limited to, the following list of genus Actinobacteria, Actinomyces, Bacillales, Bacillus, Clostridium, Corynebacterium, Enterococcus, Lactobacillales, Listeria, Nocardia, Propionibacterium, Rhodococcus equi, Sarcina, Solobacterium, Staphylococcus, Streptococcus, Acetic acid bacteria, Acinetobacter, Bacteroides, Burkholderia, Bdellovibrio, Coxiella, Cyanobacteria, Cytophaga, Enterobacter, Enterobacteriaceae, Escherichia, Fusobacterium, Haemophilus, Helicobacter, Klebsiella, Legionella, Leptotrichia, Moraxella, Neisseria, Proteobacteria, Proteus, Pseudomonas, Rickettsia, Salmonella, Serratia, Shigella, Spirochaete, Stenotrophomonas, Typhus, Vampirococcus, Verminephrobacter, Vibrio, Wolbachia.

Further, the examples of fungi to which, the solutions of the present application are applicable include but are not limited to: Alternaria alternata, Aspergillus flavus, Aspergillus terreus, Aspergillus fumigatus, Aspergillus repens, Aspergillus versicolor, Candida albicans, Chaetomium globosum, Cladosporium cladosporioides, Cladosporium herbarum, Cladosporium sphaerospermum, Coniophora puteana, Curvularia genticulata, Diplodia natalensis, Epidermophytonfloccosum, Fusarium oxysporum, Gliocladium virens, Gloeophyllum trabeum, Humicola grisea, Lecythophora mutabilis, Lentinus cyaihiformis, Lentinus lepidus, Memnionella echinata, Mucor indicus, Mucor racemosus, Oligoporus placenta, Paecilomyces variotii, Penicillium citrinum, Penicillium funiculosum, Penicillium ochrochloron, Penicillium purpurogenum, Penicillium pinophilum, Penicillium variabile, Petriella setifera, Phanerochaete chrysosporium, Phoma violacea, Poria placenta, Rhodotorula rubra, Schizophyllum commune, Sclerophoma phytiophila Scopulariopsis brevicaulis, Serpula laaymans, Sporobolomyces roseus, Stemphyliwn dendriticum, Trichophyton mentagrophytes, Trichurus spiralis, Trichophyton rubruni, Ulocladium atrum and Ulocladium chartarum.

In another embodiment of present application, the biodegradable aqueous solution of BIT composition is stable for at least two years at room temperature or stable for at least about 5 freeze/thaw cycles when the temperatures is cycled from 50° C. to −24° C. in every 24 hours or stable for at least 4 weeks at about 50° C.

The biodegradable aqueous solution of BIT composition of the present application is easily flowable by its own gravity, or through any conventional, mechanical or pneumatic pump known in the art.

Further, the aqueous solution composition of the present application does not dry up on storage or on transit for at least 18 months at room/ambient temperature. Also, the aqueous solution does not even crystallize-out or precipitate-out during storage or on transit phase. The aqueous BIT solution of present application is non-crystallizable at ambient temperature or greater than 5° C.

The aqueous solution of BIT comprises significantly high-content of aqueous medium, of at least 50% of the total composition. The preferred range of aqueous medium is from about 50% to about 85% by wt. The most preferred range of aqueous medium is from about 70% to 80% by wt. of the total composition.

In order to prepare an aqueous BIT composition, the preferred aqueous medium can be any type of water that is known in the art for this purpose and preferably selected from treated-water, purified-water, distilled water, de-ionized water, double distilled water, triple distilled water, tap water, de-mineralized water, reverse-osmosis water alone or in combination thereof. This added water to the composition is in addition to water found in or with other components of the present application.

In a preferred embodiment of the present application, an environment-friendly, biodegradable, non-corrosive aqueous solution of 1,2-benzisothiazolin-3-one (BIT) comprises: (i) at least about 5 wt. % to about 50 wt. % of 1,2-benzisothiazolin-3-one (BIT); (ii) about 5 wt. % to 15 wt. % of pottasium hydroxide (KOH), a neutralizing agent; (iii) about 0.5 wt. % to about 4 wt. % of glutamic acid-N,N-diacetic acid tetrasodium salt, a chelating agent; (iv) about 0.01 wt. % to about 20 wt. % of at least one C₆-alkyl polyglucoside, a solubilizer; (v) about 0.1 wt. % to about 2.0 wt. % of polyvinyl alcohol (PVA), a crystal modifier; and (vi) about 50 wt. % to about 85 wt. % of water; and wherein said aqueous solution is free from volatile organic compounds (VOC's), glycerols, polyglycerols, derivatives of glycerols, glycols, polyglycols and/or derivatives of glycols, and wherein, the frozen aqueous solution of isothiazolin-3-one is capable of completely thawing within two hours at room temperature or at about 25° C. to about 30° C.

One important aspect of the present application is to provide a process for preparing an environment-friendly, biodegradable, non-corrosive aqueous solution of benzisothiazolin-3-one comprising preparing a homogenous mixture of (a) at least about 5 wt. % to about 50 wt. % of 1,2-benzisothiazolin-3-one which is pre-neutralized with about 5 wt. % to 15 wt. % of neutralizing agent; (b) about 0.01 wt. % to about 20 wt. % of at least one biodegradable chelating agent; (c) about 0.01 wt. % to about 20 wt. % of at least one alkyl polyglucoside, a solubilizer; (d) about 0.1 wt. % to about 2.0 wt. % of polyvinyl alcohol (PVA), a crystal modifier; and (e) about 50 wt. % to about 85 wt. % of water by high shear mixing in a reactor preferably for about 30 minutes.

The solution according to claim 1 can be employed in the field of paint, building materials, stucco, concrete, caulks, sealants, joints, adhesives, leather, wood, inks, pigment dispersions, metal working fluids, drilling mud, clay slurries, agricultural applications, seed coatings, pesticide compositions, toiletry, household, cleaning, disinfecting, enzyme formulations, latex, paint, in-can preservation, coatings and/or laundry.

Further, the present invention is illustrated in detail by way of the below given examples. The examples are given herein for illustration of the invention and are not intended to be limiting thereof.

### EXAMPLE 1

| Ingredients | wt. % |
|---|---|
| Water | 49.80 |
| BIT (84% A.I.) | 23.00 |
| Potassium hydroxide (50% solution) | 12.70 |
| Glutamic acid, N,N-diacetic acid tetrasodium | 2.50 |
| salt (GLDA-Na₄) | |
| PVA (4-88) | 2.00 |
| Alkyl polyglucoside (C₆) | 10.00 |

pH of the composition is around 7.5

### EXAMPLE 2

| Ingredients | wt. % |
|---|---|
| Water | 49.80 |
| BIT (84% A.I.) | 23.00 |
| Potassium hydroxide (50% solution) | 12.70 |
| Tetrasodium 3-Hydroxy-2,2′-Iminodisuccinate | 2.50 |
| (HIDS) | |
| PVA (4-88) | 2.00 |
| Alkyl polyglucoside (C₆) | 10.00 |

pH of the composition is around 7.5

### EXAMPLE 3

| Ingredients | wt. % |
|---|---|
| Water | 49.80 |
| BIT (84% A.I.) | 23.00 |
| Potassium hydroxide (50% solution) | 12.70 |
| Ethylenediamine-N,N′-disuccinic acid (EDDS) | 2.50 |
| PVA (4-88) | 2.00 |
| Alkyl polyglucoside (C₆) | 10.00 |

pH of the composition is around 7.5

### EXAMPLE 4

| Ingredients | wt. % |
|---|---|
| Water | 49.80 |
| BIT (84% A.I.) | 23.00 |
| Potassium hydroxide (50% solution) | 12.70 |
| L-aspartic acid, N,N-diacetic acid tetrasodium | 2.50 |
| salt (ASDA-4Na) | |
| PVA (4-88) | 2.00 |
| Alkyl polyglucoside (C₆) | 10.00 |

pH of the composition is around 7.5

### EXAMPLE 5

| Ingredients | wt. % |
|---|---|
| Water | 49.80 |
| BIT (84% A.I.) | 23.00 |
| Potassium hydroxide (50% solution) | 12.70 |
| tetrasodium iminodisuccinate | 2.50 |
| PVA (4-88) | 2.00 |
| Alkyl polyglucoside (C₆₎ | 10.00 |

pH of the composition is around 7.5

### EXAMPLE 6

| Ingredients | wt. % |
|---|---|
| Water | 49.80 |
| BIT (84% A.I.) | 23.00 |
| Potassium hydroxide (50% solution) | 12.70 |
| Glutamic acid, N,N-diacetic acid tetrasodium | 2.50 |
| salt (GLDA-Na₄) | |
| PVA (4-88) | 2.00 |
| Alkyl polyglucoside (C₈-C₁₀) | 10.00 |
| (Agnique 8107) | |

pH of the composition is around 7.5

### EXAMPLE 7

| Ingredients | wt. % |
|---|---|
| Water | 49.80 |
| BIT (84% A.I.) | 23.00 |
| Potassium hydroxide (50% solution) | 12.70 |
| Glutamic acid, N,N-diacetic acid tetrasodium | 2.50 |
| salt (GLDA-Na₄) | |
| PVA (4-88) | 2.00 |
| Alkyl polyglucoside (C₈-C₁₀₎ | 10.00 |
| Triton BG-10 | |

pH of the composition is around 7.5

### EXAMPLE 8

| Ingredients | wt. % |
|---|---|
| Water | 49.80 |
| BIT (84% A.I.) | 23.00 |
| Potassium hydroxide (50% solution) | 12.70 |
| Glutamic acid, N,N-diacetic acid tetrasodium | 2.50 |
| salt (GLDA-Na₄) | |
| PVA (4-88) | 2.00 |
| Capryl Glucoside (Alkyl polyglucoside) | 10.00 |

pH of the composition is around 7.5

### EXAMPLE 9

| Ingredients | wt. % |
|---|---|
| Water | 49.80 |
| BIT (84% A.I.) | 23.00 |
| Potassium hydroxide (50% solution) | 12.70 |
| Glutamic acid, N,N-diacetic acid tetrasodium | 2.50 |
| salt (GLDA-Na₄) | |
| PVA (4-88) | 2.00 |
| Alkyl polysaccharide (C₉-C₁₁) | 10.00 |

pH of the composition is around 7.5

### EXAMPLE 10

| Ingredients | wt. % |
|---|---|
| Water | 23.90 |
| BIT (84% A.I.) | 40.00 |
| Potassium hydroxide (50% solution) | 14.85 |
| Glutamic acid, N,N-diacetic acid tetrasodium | 2.50 |
| salt (GLDA-Na₄) | |
| PVA (4-88) | 2.00 |
| Alkyl polyglucoside (C₆) | 16.75 |

pH of the composition is around 7.5

### EXAMPLE 11

| Ingredients | wt. % |
|---|---|
| Water | 7.68 |
| BIT (84% A.I.) | 50.00 |
| Potassium hydroxide (50% solution) | 16.32 |
| Glutamic acid, N,N-diacetic acid tetrasodium | 2.50 |
| salt (GLDA-Na₄) | |
| PVA (4-88) | 2.00 |
| Alkyl polyglucoside (C₆) | 21.50 |

pH of the composition is around 7.5

While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those skilled in the art without departing from the scope and spirit of this invention.

What is claimed is:

1. An environment-friendly, biodegradable, non-corrosive aqueous biocidal solution comprising:
i. at least about 5 wt. % to about 50 wt. % of 1,2-benzisothiazolin-3-one (BIT);
ii. about 5 wt. % to 15 wt. % of neutralizing agent;
iii. about 0.01 wt. % to about 20 wt. % of at least one biodegradable chelating agent;
iv. about 0.01 wt. % to about 20 wt. % of at least one alkyl polyglucoside, a solubilizer;
v. about 0.1 wt. % to about 2.0 wt. % of polyvinyl alcohol (PVA), a crystal modifier; and
vi. about 50% to about 85% by wt. of water;
and wherein said aqueous solution is free from volatile organic compounds (VOC's), glycerols, polyglycerols, derivatives of glycerols, glycols, polyglycols and/or derivatives of glycols, and wherein the frozen aqueous solution of BIT is capable of completely thawing within two hours at room temperature or at about 25° C. to about 30° C.

2. The solution according to claim 1, wherein the neutralizing agent is alkali metal hydroxides.

3. The solution according to claim 1, wherein the neutralizing agent is sodium hydroxide (NaOH) or potassium hydroxide (KOH).

4. The solution according to claim 1, wherein said biodegradable chelating agent is selected from the group consisting of S,S-ethylenediaminedisuccinic acid (EDDS), Ethylene diamine-N,N′-disuccinic acid, or alkali or alkaline earth salts, Trisodium ethylene diamine-N,N-disuccinate (EDDS), (S,S)-Iminodisuccinic acid, (S,R)-Imino-disuccinic acid, hydroxyiminodisuccinic acid (HIDS), Trisodium methylglycine-N,Ndiacetate, Cysteic acid-N,N-diacetic acid, Cysteic acid-N-monoacetic acid, Alanine-N-monoacetic acid, β-Alanine-N,N-diacetic acid, (S)-α-Alanine-N,N-diacetic acid, N-[2-(3-Hydroxysuccinyl)]-L-serine, Methyliminodiacetic acid and their alkali metal salts, (S)-Aspartic acid-monoacetic acid, (S)-Aspartic acid-N,N-diacetic acid, (S)-Aspartic acid-monopropionic acid, N-(3-Hydroxysuccinyl)-aspartic acid, (S)-2-Sulfomethylaspartic acid, (S)-2-Sulfoethylaspartic acid, (S)-Glutamic acid-N,N-diacetic acid, (S)-2-Sulfomethylglutamic acid, (S)-2-Sulfoethylglutamic acid, (S)-Serine-N,N-diacetic acid, (S)-Phenylalanine-N,N-diacetic acid and alkali metal salts, Glutamic acid diacetic acid (GLDA), a GLDA salt, a GLDA derivative, a tetrasodium or ammonium salt of GLDA, Methylglycine diacetic acid (MGDA), Polyamino disuccinic acids, N-bis-[2-(1,2-Dicarboxyethoxy)ethyl]glycine (BCA6), N-bis-[2-(1,2-Dicarboxyethoxy)ethyl]aspartic acid (BCA5), N-bis-[2-(1,2-Dicarboxyethoxy)ethyl]-methylglycine (MCBA5), N-tris-[(1,2-Dicarboxyethoxy)ethyl]amine (TCA6), N-Methyliminodiacetic acid (MIDA), Iminodiacetic acid (IDA), N-(2-Acetamido)iminodiacetic acid (ADA), Hydroxymethyl-iminodiacetic acid, 2-(2-Carboxyethylamino)succinic acid (CEAA), 2-(2-Carboxymethylamino)succinic acid (CMAA), Diethylenetriamine-N,N″-disuccinic acid, Triethylenetetramine-N,N′″-disuccinic acid, 1,6-Hexamethylenediamine-N,N′-disuccinic acid, Tetraethylenepentamine-N,N″″-disuccinic acid, 2-Hydroxypropylene-1,3-diamine-N,N′-disuccinic acid, 1,2-Propylenediamine-N,N′-disuccinic acid, 1,3-Propylenediamine-N,N′-disuccinic acid, cis-Cyclohexanediamine-N,N′-disuccinic acid, trans-Cyclohexanediamine-N,N′-disuccinic acid, Ethylene-bis-(oxyethylenenitrilo)-N,N′-disuccinic acid, Glucoheptanoic acid, alone or in combination.

5. The solution according to claim 1, wherein said biodegradable chelating agent is glutamic acid-N,N-diacetic acid tetrasodium salt.

6. The solution according to claim 1, wherein said alkyl polyglucoside comprises a C₆-C₁₆ alkyl polyglucoside.

7. The solution according to claim 1, wherein the pH is from about 7.5 to about 8.5.

8. The solution according to claim 1 capable of inhibiting or killing gram (+) bacterial strains, gram (−) bacterial strains, fungi, yeasts and/or mold spores.

9. The solution according to claim 1 capable of inhibiting or killing Staphylococcus aureus, Staphylococcus epidermidis, Streptococcus pneumoniae, Streptococcus pyogenes, Enterococcus faecalis, Haemophilus influenzae, Moraxella species, salmonella species, campylobacter species, Pseudomonus aeruginosa, Clostridium botulinum, Clostridium perfringens, Corynebacteria species, Diplococci species, Mycobacteria species, Streptomyces species, Escherichia coli, Salmonella typhimurium, Salmonella enteritidis, Vibrio parahaemolyticus, Bacillus anthracis, Bacillus azotoformans, Bacillus cereus, Bacillus coagulans, Bacillus israelensis, Bacillus larvae, Bacillus mycoides, Bacillus polymyxa, Bacillus pumilis, Bacillus stearothormophillus, Bacillus subtilis, Bacillus thuringiensis, Bacillus validus, Bacillus weihenstephanensis, Bacillus pseudomycoides, Burkholderia cepacia, Burkholderia multivorans, Burkholderia cenocepacia, Burkholderia vietnamiensis, Burkholderia stabilis, Burkholderia ambifaria, Burkholderia dolosa, Burkholderia anthina, Burkholderia pyrrocinia, Candida tropicalis, Candida albicans, Hansenula anomala, Saccharomyces cerevisiae, Torulaspora delbreuckii, Zygosaccharomyces bailii, Zygosaccharomyces rouxii, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, and/or Mucor racemosus.

10. The solution according to claim 1, which is stable for at least two years at ambient temperature or stable for at least 5 freeze/thaw cycles when the temperature is cycled from 50° C. to −24° C. in every 24 hours or stable for at least 4 weeks at about 50° C.

11. The solution according to claim 1, wherein the BIT in said aqueous solution is non-crystallizable at ambient temperature or greater than 5° C.

12. The solution according to claim 1 that is storage and transit stable.

13. The solution according to claim 1 employed in the field of paint, building materials, stucco, concrete, caulks, sealants, joints, adhesives, leather, wood, inks, pigment dispersions, metal working fluids, drilling mud, clay slurries, agricultural applications, seed coatings, pesticide compositions, toiletry, household, cleaning, disinfecting, enzyme formulations, latex, paint, in-can preservation, coatings and/or laundry.

14. An environment-friendly, biodegradable, non-corrosive aqueous solution of isothiazolin-3-one comprising:
i. at least about 5 wt. % to about 50 wt. % of 1,2-benzisothiazolin-3-one (BIT);
ii. about 5 wt. % to 15 wt. % of pottasium hydroxide (KOH), a neutralizing agent;
iii. about 0.5 wt. % to about 4 wt. % of glutamic acid-N,N-diacetic acid tetrasodium salt, a chelating agent;
iv. about 0.01 wt. % to about 20 wt. % of at least one C₆-alkyl polyglucoside, a solubilizer;
v. about 0.1 wt. % to about 2.0 wt. % of polyvinyl alcohol (PVA), a crystal modifier; and
vi. about 50 wt. % to about 85 wt. % of water;
and wherein said aqueous solution is free from volatile organic compounds (VOC's), glycerols, polyglycerols, derivatives of glycerols, glycols, polyglycols and/or derivatives of glycols, and wherein, the frozen aqueous solution of BIT is capable of completely thawing within two hours at room temperature or at about 25° C. to about 30° C.

15. A process for preparing an environment-friendly, biodegradable, non-corrosive aqueous solution of 1,2-benzisothiazolin-3-one BIT comprising preparing a homogenous mixture of (a) at least about 5 wt. % to about 50 wt. % of 1,2-benzisothiazolin-3-one BIT which is pre-neutralized with about 5 wt. % to 15 wt. % of neutralizing agent; (b) about 0.01 wt. % to about 20 wt. % of at least one biodegradable chelating agent; (c) about 0.01 wt. % to about 20 wt. % of at least one alkyl polyglucoside, a solubilizer; (d) about 0.1 wt. % to about 2.0 wt. % of polyvinyl alcohol (PVA), a crystal modifier; and (e) about 50 wt. % to about 85 wt. % of water by high shear mixing in a reactor.
